(19) United States
(12) Patent Application Publication
(10) Pub. No.: US 2009/0219458 A1
(43) Pub. Date: Sep. 3, 2009

(54) LIQUID CRYSTAL DISPLAY DEVICE AND ELECTRONIC APPARATUS

(75) Inventors: Kazuyuki Endo, Kanagawa (JP); Hironao Tanaka, Kanagawa (JP); Eiji Sakai, Kanagawa (JP); Shingo Kataoka, Tokyo (JP); Seiji Uejima, Kanagawa (JP); Ryo Yamaoka, Kanagawa (JP); Shuichi Tatemori, Kanagawa (JP); Takeo Koito, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/389,787

(22) Filed: Feb. 20, 2009

(30) Foreign Application Priority Data
Feb. 29, 2008 (JP) 2008-049789

(51) Int. Cl. G02F 1/1335; G02F 1/1337; G02F 1/1333

(52) U.S. Cl. 349/58; 349/123; 349/110

(57) ABSTRACT

Disclosed herein is a liquid crystal display device having a liquid crystal between a drive substrate and a counter substrate, and a plurality of main pixels disposed so as to compose a display area, wherein either a liquid crystal alignment controlling factor or a spacer for substrate distance setting is provided in each of at least two sub-pixels of a plurality of sub-pixels composing the main pixel; and light shielding members provided in the at least two sub-pixels so as to correspond to either the liquid crystal alignment controlling factors or the spacers, respectively, are different in area in planar view from each other.

### CROSS REFERENCES TO RELATED APPLICATIONS

The present invention contains subject matter related to Japanese Patent Application JP 2008-049789 filed in the Japan Patent Office on Feb. 29, 2008, the entire contents of which being incorporated herein by reference.

### BACKGROUND OF THE INVENTION

1. Field of the Invention

The present invention relates to a liquid crystal display device in which a liquid crystal is sealingly enclosed in a space defined between a drive substrate and a counter substrate, and an electronic apparatus including the same.

2. Description of the Related Art

A liquid crystal display device has such a structure that a drive substrate on which drive elements such as Thin Film Transistors (TFTs) are provided so as to correspond to pixels, respectively, and a counter substrate on which a color filter and the like are formed are stuck to each other at a predetermined distance, and a liquid crystal is sealingly enclosed in a space defined between the drive substrate and the counter substrate. In a liquid crystal display device for displaying thereon a color image, one pixel (main pixel) is composed of three sub-pixels corresponding to the three primary colors, i.e., Red (R), Green (G) and Blue (B). Thus, a desired color image is displayed by driving the sub-pixels.

In such a liquid crystal display device, the adjustment needs to be carried out so as to obtain a target chromaticity by using the applied color filter having R, G and B. In particular, in recent years, a color temperature of a white color has been severely requested. As a result, the adjustment for the white chromaticity coordinates has become an important factor for the request for the color temperature of the white color.

Here, for the adjustment for the color temperature of the white color in the liquid crystal display device, when none of materials is changed, there is adopted a technique with which a liquid crystal gap (the distance defined between the drive substrate and the counter substrate) is adjusted, or a single color chromaticities of R, G and B are adjusted by using a film thickness of the color filter.

However, with the adjustment for the liquid crystal gap, the white chromaticity coordinates can be moved merely in a determined direction through the adjustment. In addition, with the adjustment for the single color chromaticities of R, G and B, the white chromaticity coordinates may not be moved unless the colors are extremely changed. As a result, there is encountered a problem that a color reproduction range becomes narrower than target one, or the coordinates are extremely biased.

On the other hand, although the white chromaticity coordinates can be changed by replacing a backlight of the liquid crystal display device with another one, there is a limit to a chromaticity range of the backlight, and thus it may be impossible to carry out the adjustment beyond the chromaticity range.

In order to cope with this situation, there are a devised method of changing sizes of pixels so as to correspond to colors, respectively, and a devised method of adjusting chromaticities of pixels corresponding to the respective colors by newly providing a pattern for light shielding within each of pixels. These methods, for example, are described in Japanese Patent Laid-Open Nos. 2007-17619 and 2005-141180.

### SUMMARY OF THE INVENTION

However, with the method of changing the sizes of the pixels so as to correspond to colors, respectively, designs of drive circuits need to be changed so as to correspond to colors, respectively, or the drive circuit needs to be designed in correspondence to the largest pixel. Thus, this method involves such a problem that a large load is imposed on the circuit design. In addition, with the method of newly providing the pattern for light shielding within each of the pixels, there is caused a problem that a restriction is provided for the design of the circuit within each of the pixels, thereby reducing the degree of freedom of the design.

In the light of the foregoing, it is therefore desirable to provide a liquid crystal display device which is capable of adjusting a transmittance by utilizing an existing light shielding member without specially providing a dedicated pattern for transmittance adjustment, and an electronic apparatus including the same.

In order to attain the desire described above, according to an embodiment of the present invention, there is provided a liquid crystal display device having a liquid crystal between a drive substrate and a counter substrate, and a plurality of main pixels disposed so as to compose a display area, in which either a liquid crystal alignment controlling factor or a spacer for substrate distance setting is provided in each of at least two sub-pixels of a plurality of sub-pixels composing the main pixel; and light shielding members provided in the at least two sub-pixels so as to correspond to either the liquid crystal alignment controlling factors or the spacers, respectively, are different in area in planar view from each other.

In the liquid crystal display device, either the liquid crystal alignment controlling factor or the spacer is provided in each of the at least two sub-pixels of the plurality of sub-pixels composing the main pixel. In order to prevent light leakage due to the generation of the alignment turbulence caused by presence of either the liquid crystal alignment controlling factor or the spacer, the light shielding members are provided so as to correspond to the positions of either the liquid crystal alignment controlling factors or the spacers, respectively. In the embodiment of the present invention, the light shielding member is used as a member as well for the adjustment for the transmittance of the sub-pixel. As a result, a balance among the transmittances of the plurality of pixels composing the main pixel can be adjusted without providing a pattern for transmittance adjustment as another member.

Here, the light shielding member may be similar in outer shape in planer view to either the liquid crystal alignment controlling factor or the spacer. As a result, it is possible to achieve a balance between reliable prevention of the light leakage due to the generation of the liquid crystal alignment turbulence caused by the presence of either the liquid crystal alignment controlling factor or the spacer, and desired transmittance adjustment.

In addition, the light shielding members may be disposed within a display area independently of each other, which results in that the transmittance can be adjusted without exerting an influence on a design of a circuit pattern in the periphery of the display area.

According to another embodiment of the present invention, there is provided an electronic apparatus including a liquid crystal display device provided in a main body chassis, in which in the liquid crystal display device, a liquid crystal is sealingly enclosed between a drive substrate and a counter substrate, and a plurality of main pixels are disposed so as to compose a display area; either a liquid crystal alignment controlling factor or a spacer for substrate distance setting is provided in each of at least two sub-pixels of a plurality of sub-pixels composing the main pixel; and light shielding members provided in the at least two sub-pixels so as to correspond to either the liquid crystal alignment controlling factors or the spacers, respectively, are different in area in planar view from each other.

In any of the embodiments of the present invention, the light shielding member in the liquid crystal display device is used as the member as well for the adjustment for the transmittances of the sub-pixel. As a result, the balance of the transmittances of the plurality of sub-pixels composing the main pixel can be adjusted without providing a pattern for the transmittance adjustment as another member.

As set forth hereinabove, according to the embodiment of the present invention, in the adjustment for the transmittance of the sub-pixel, the transmittance can be adjusted by utilizing the existing light shielding member without specifically providing the dedicated pattern for the transmittance adjustment. As a result, the desired transmittance adjustment can be carried out while the degree of freedom in the circuit design within the pixel, and thus it is possible to exactly set the chromaticity coordinates of the liquid crystal display device.

### BRIEF DESCRIPTION OF THE DRAWINGS

FIG. 1 is a top plan view, partly broken away to show an interior structure, of a liquid crystal display device according to an embodiment of the present invention;

FIG. 2 is a cross sectional view taken on line A-A′ of FIG. 1;

FIG. 3 is a circuit diagram, partly in block, showing an example of drive circuits of the liquid crystal display device of the embodiment shown in FIG. 1;

FIG. 4 is a diagram explaining a structural example of pixels in the liquid crystal display device of the embodiment shown in FIG. 1;

FIGS. 5A and 5B are respectively a diagram explaining a structural example of a light shielding member in the related art, and a diagram explaining a structural example of a light shielding member in the liquid crystal display device of the embodiment shown in FIG. 1;

FIG. 6 is a diagram explaining another structural example of a light shielding member having another shape;

FIG. 7 is a diagram explaining still another structural example of a light shielding member having still another shape;

FIG. 8 is a schematic cross sectional view explaining a structure of a sub-pixel of an example;

FIG. 9 is a schematic cross sectional view explaining a structure of a sub-pixel of another example;

FIG. 10 is a schematic top plan view explaining the structure of the sub-pixel of the another example;

FIG. 11 is a schematic cross sectional view showing a structure of a sub-pixel of still another example in which a color filter is provided with a light shielding member;

FIG. 12 is a schematic top plan view showing the structure of the sub-pixel of the still another example in which the color filter is provided with the light shielding member;

FIG. 13 is a schematic cross sectional view showing a structure of a sub-pixel of yet another example in which the color filter is provided with the light shielding member in a structure including a liquid crystal alignment controlling factor;

FIG. 14 is a schematic view showing a flat type module shaped display device to which the embodiment of the present invention is applied;

FIG. 15 is a perspective view of a television set as an example of application to which the embodiment of the present invention is applied;

FIGS. 16A and 16B are respectively a perspective view of a digital camera as another example of application, when viewed from a front side, to which the embodiment of the present invention is applied, and a perspective view of the digital camera as the another example of application, when viewed from a back side, to which the embodiment of the present invention is applied;

FIG. 17 is a perspective view showing a notebook-size personal computer as still another example of application to which the embodiment of the present invention is applied;

FIG. 18 is a perspective view showing a video camera, as yet another example of application, to which the embodiment of the present invention is applied;

FIGS. 19A to 19G are respectively a front view of mobile terminal equipment, for example, a mobile phone as a further example of application, in an open state, to which the embodiment of the present invention is applied, a side elevational view thereof, a front view thereof in a close state, a left side elevational view thereof, a right side elevational view thereof, a top plan view thereof, and a bottom view thereof;

FIG. 20 is a block diagram showing an entire configuration of a display image pickup device to which the liquid crystal display device of the embodiment is applied;

FIG. 21 is a block diagram showing a configuration of an I/O display panel provided in the display image pickup device shown in FIG. 20;

FIG. 22 is a circuit diagram showing a configuration of each of pixels in a display area of the I/O display panel shown in FIG. 21;

FIG. 23 is a circuit diagram, partly in block, explaining a connection relationship between each of the pixels in the display area, and an H driver for read; and

FIG. 24 is a timing chart explaining a relationship between an ON/OFF stare of a backlight and a display state of the I/O display panel.

### DETAILED DESCRIPTION OF THE PREFERRED EMBODIMENT

An embodiment of the present invention will be described in detail hereinafter with reference to the accompanying drawings.

### Entire Structure of Liquid Crystal Display Device

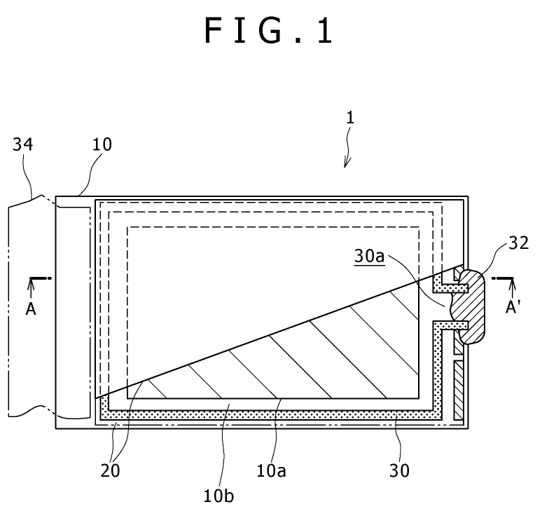

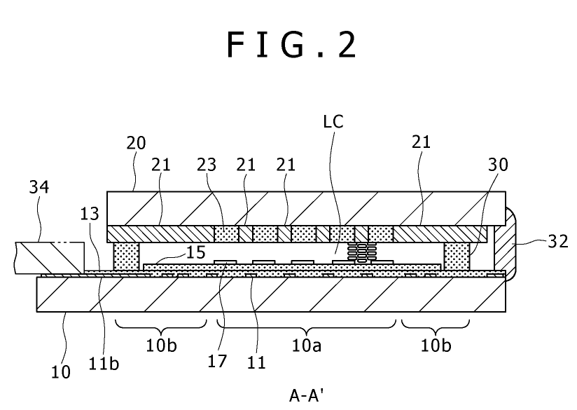

FIG. 1 is a top plan view, partly broken away to show an interior structure, of a liquid crystal display device according to an embodiment of the present invention. FIG. 2 is a cross sectional view taken on line A-A′ of FIG. 1. A schematic structure of the liquid crystal display device according to the embodiment of the present invention will be described hereinafter with reference to FIGS. 1 and 2.

The liquid crystal display device 1 shown in FIGS. 1 and 2 includes a drive substrate 10 having a drive circuit formed thereon, a counter substrate 20 disposed so as to face the drive substrate 10, a sealing agent 30 held between the drive substrate 10 and the counter substrate 20, a sealant 32 sealing an inlet 30a for injection of the sealing agent 30, and a liquid crystal layer LC filled in a space defined between the drive substrate 10 and the counter substrate 20.

Of them, the drive substrate 10 includes drive circuits which are disposed in a display area 10a set at a central portion of the liquid crystal display device 1, and in a peripheral area 10b of the display area 10a, respectively. This drive circuit, as will be described in detail later, is a pixel circuit and a peripheral circuit each composed of a thin film transistor and a capacitor.

In addition, an extraction wiring 11b, for example, is provided in the same layer as that of a gate electrode 11 composing the thin film transistor of the drive circuit described above on the drive substrate 10. The gate electrode 11 and the extraction wiring 11b, for example, is each formed from a molybdenum (Mo) film. Also, the extraction wiring 11b is provided from a position overlapping the sealing agent 30 to an outside of the position in the periphery of the drive substrate 10.

A circuit wiring (not shown) and the like are formed on an insulating film 13 covering each of the gate electrode 11 and the extraction wiring 11b, and a planarizing insulating film 15 is formed so as to cover the circuit wiring and the like. A plurality of pixel electrodes 17 each connected to the circuit wiring are disposed in a matrix in the display area 10a on the planarizing insulating film 15.

Also, an aligned film (not shown) is provided so as to cover the plurality of pixel electrodes 17.

On the other hand, the counter substrate 20 has the same shape as that of the drive substrate 10. A portion above the drive substrate 10 is opened merely in the peripheral direction, along which the extraction wiring 11b is extracted, in the drive substrate 10. The counter substrate 20 is provided with a black matrix 21 corresponding to the peripheral area 10b surrounding the display area 10a set at the central portion of the liquid crystal display device 1. In addition, the black matrix 21 may also be disposed in a position corresponding to a portion between each two pixel electrodes 17 in the inside as well of the display area 10a.

In addition, a color filter 23 having the corresponding colors are provided in the display area 10a surrounded by the black matrix 21.

Moreover, although an illustration is omitted here, a counter electrode as a common electrode and an aligned film are formed in a lamination form in this order over an entire surface of the display area 10a so as to cover each of the black matrix 21 and the color filters 23.

The sealing agent 30 is continuously provided in a circumferential edge of the space defined between the drive substrate 10 and the counter substrate 20 so as to face the side peripheries of the drive substrate 10 and the counter substrate 20 with at least one opening portion as the inlet 30a.

The sealing agent 30 is drawn in pattern thereof on one substrate side by, for example, utilizing the screen printing or the dispenser. Thus, the sealing agent 30 is provided slightly inside from the circumferential edges of the drive substrate 10 and the counter substrate 20 merely in a direction of an end edge in which the inlet 30a is provided. As a result, a portion of the inlet 30a from a display area 10a side to the side peripheries of the drive substrate 10 and the counter substrate 20 is in a state of being shaped into a neck-like shape.

The sealant 32 is applied to the peripheries of the drive substrate 10 and the counter substrate 20 so as to seal the inlet 30a for injection of the sealing agent 30.

The liquid crystal layer LC is composed of liquid crystal molecules each having dielectric anisotropy which is selected in accordance with a drive mode of the liquid crystal display device 1. It is noted that in addition to the liquid crystal layer LC, a plurality of spacers for setting a distance between the drive substrate 10 and the counter substrate 20 in a predetermined state is held between the drive substrate 10 and the counter substrate 20. These spacers are columnar spacers which are previously formed either on the drive substrate 10 or on the counter substrate 20.

In addition, a flexible printed circuit board 34 having an external circuit formed therein is connected to the extraction wiring 11b as may be necessary.

### Configurations of Drive Circuits

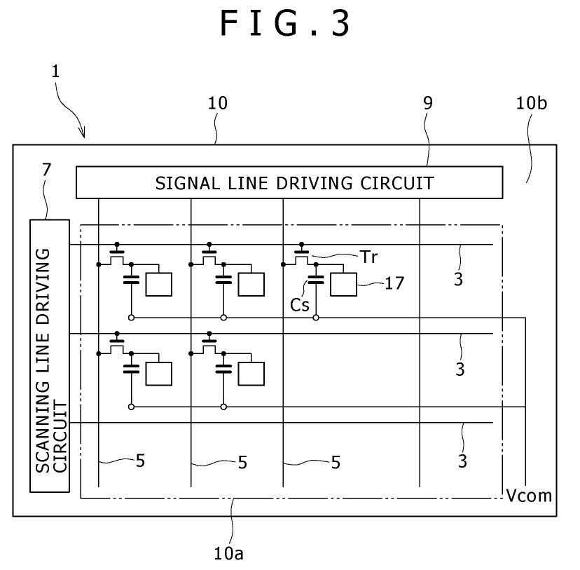

FIG. 3 is a circuit diagram, partly in block, showing an example of drive circuits of the liquid crystal display device described above.

As shown in the figure, in the active matrix type liquid crystal display device 1, a plurality of scanning lines 3, and a plurality of signal lines 5 are wired horizontally and vertically, respectively, in the display area 10a set on the drive substrate 10 side. Also, the pixels are provided so as to correspond to intersection portions between the scanning lines 3 and the signal lines 5, respectively. In such a manner, the display area 10a is configured as a pixel array portion. A pixel circuit provided in each of the pixels, for example, is composed of a pixel electrode 17, a thin film transistor Tr, and a hold capacitor Cs.

On the other hand, a scanning line driving circuit 7, and a signal line driving circuit 9 are disposed in the peripheral area 10b. In this case, the scanning line driving circuit 7 scans and drives the scanning lines 3, and the signal line driving circuit 9 supplies a video signal (that is, an input signal) corresponding to luminance information to the signal lines 5.

In the panel configuration as described above, the video signal written from the corresponding one of the signal lines 5 to the pixel through the thin film transistor Tr is held in the hold capacitor Cs, and a voltage corresponding to an amount of signal thus held is supplied to the pixel electrode 17 through the driving operation by the scanning line driving circuit 7. On the other hand, a common potential Vcom is applied to the counter electrode as the common electrode connected to the other electrode of the hold capacitor Cs. As a result, the liquid crystal molecules composing the liquid crystal layer LC are rotated at a predetermined angle within the substrate plane in accordance with an electric field generated by applying the voltage across the pixel electrode 17 and the counter electrode, thereby controlling light transmission of a display light.

It is noted that the configuration of the pixel circuit as described above is merely an example. Thus, the pixel circuit may be configured by providing a capacitor in the pixel circuit, or by providing a plurality of transistors in the pixel circuit as may be necessary. In addition, a necessary drive circuit is added to the peripheral area 10b in accordance with a change in design of the pixel circuit. In addition, the embodiment of the present invention can be applied to the liquid crystal display device having all the liquid crystal drive modes. Moreover, the embodiment of the present invention can be applied to a passive matrix type liquid crystal display device as well as to the active matrix type liquid crystal display device. In this case, the same effects as those of the active matrix type liquid crystal display device can be obtained.

### Pixel Structure

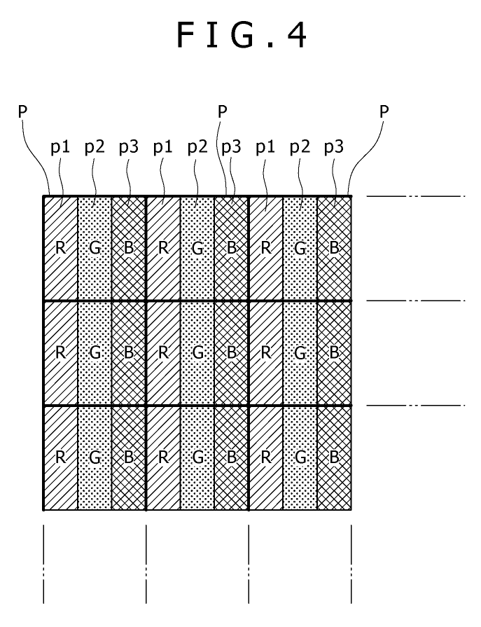

FIG. 4 is a schematic diagram explaining a structural example of the pixel. A plurality of pixels (main pixels P) are disposed in a matrix in the display area 10a of the liquid crystal display device 1. Each of the main pixels P is composed of a plurality of sub-pixels. In the structural example shown in FIG. 4, one main pixel P is composed of three sub-pixels, that is, a sub-pixel p1 corresponding to Red (R), a sub-pixel p2 corresponding to Green (G), and a sub-pixel p3 corresponding to Blue (B). It is noted that although a kind or disposition of the sub-pixels composing the main pixel P may be a kind or disposition other than that described above, in this embodiment, one main pixel P is composed of the three sub-pixels p1, p2 and p3 correspond to R, G and B, respectively.

In each of the sub-pixels p1, p2 and p3, the thin film transistor and the pixel electrode for drive for the liquid crystal are formed on the drive substrate 10 side, and the color filter having R, G and B of the sub-pixels p1, p2 and p3 is formed on the counter substrate 20 side. In addition, either a liquid crystal alignment controlling factor or a spacer for setting of a substrate distance is provided in each of at least two sub-pixels of a plurality of sub-pixels p1, p2 and p3.

That is to say, when a vertical alignment type liquid crystal is used as a type of the liquid crystal, a convex portion (liquid crystal alignment controlling factor) for controlling an alignment direction of the vertical alignment type liquid crystal is provided in each of the at least two sub-pixels of a plurality of sub-pixels p1, p2 and p3 on the counter substrate 20 side. In addition, even in the case of any other type of liquid crystal, a columnar spacer is provided for the purpose of precisely setting a gap defined between the drive substrate 10 and the counter substrate 20. When there are a plurality of sub-pixels p1, p2 and p3 in one main pixel P, the columnar spacer is provided in each of at least two sub-pixels.

When either such a liquid crystal alignment controlling factor or a columnar spacer is provided in each of the at least two sub-spacers, an alignment turbulence of the liquid crystal occurs by presence of either the liquid crystal alignment controlling factor or the spacer. In order to prevent light leakage caused by the alignment turbulence, a light shielding member is provided so as to correspond to the position of either the liquid crystal alignment controlling factor or the spacer. In this case, the light shielding member is provided either on the drive substrate 10 side or on the counter substrate 20 side corresponding to the position of either the liquid crystal alignment controlling factor or the spacer.

In the liquid crystal display device 1 of this embodiment, the light shielding member is used as a member as well for adjustment of transmittances of the sub-pixels p1, p2 and p3. Thus, a balance among the transmittances of a plurality of sub-pixels p1, p2 and p3 composing the main pixel P can be adjusted without specially providing a pattern for transmittance adjustment as another member.

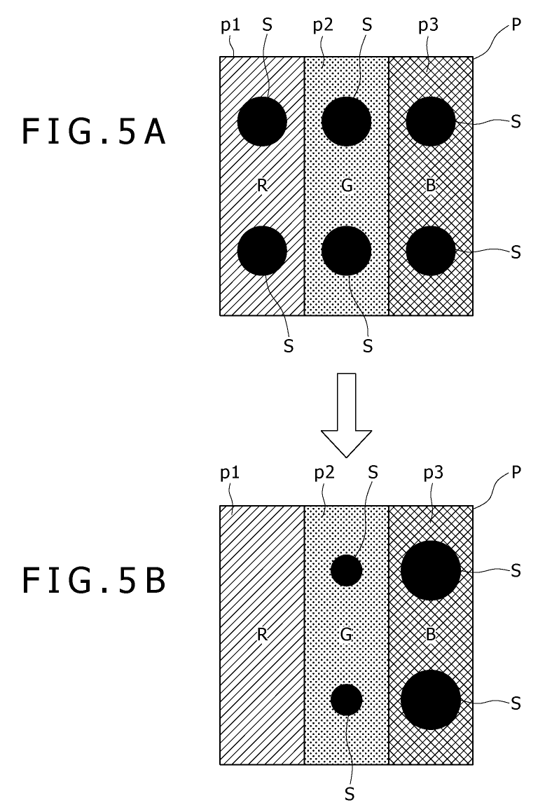

FIGS. 5A and 5B are respectively a diagram explaining a structural example of a light shielding member in the related art, and a diagram explaining a structural example of a light shielding member in the liquid crystal display device of the embodiment shown in FIG. 1. Here, FIGS. 5A and 5B show the structural examples of the light shielding members S for one main pixel P composed of the three sub-pixels p1, p2 and p3. In the case of the structural example of the light shielding members S in the related art shown in FIG. 5A, although the two light shielding members S are provided in each of the sub-pixels p1, p2 and p3 corresponding to R, G and B, respectively, outer shapes in planar view of all the light shielding members S have the same size. Here, the planar view means a state in which a planar surface of the display area 10a (refer to FIG. 1) of the liquid crystal display device 1 is viewed from the front.

On the other hand, in the embodiment shown in FIG. 5B, the light shielding member S is provided in each of the sub-pixel p2 corresponding to G, and the sub-pixel p3 corresponding to B of the sub-pixels p1, p2 and p3 corresponding to R, G and B, respectively. Also, no light shielding member S is provided in the sub-pixel p1 corresponding to R. In addition, each of the two light shielding members S provided in the sub-pixel p2 corresponding to G is different in size of an outer shape in planar view from each of the two light shielding members S provided in the sub-pixel p3 corresponding to B. That is to say, each of the two light shielding members S provided in the sub-pixel p3 corresponding to B is larger in size than each of the two light shielding members S provided in the sub-pixel p2 corresponding to G. By making the sizes of the pairs of light shielding members S in the sub-pixels p2 and p3 different from each other, it is possible to adjust a balance among the transmittances of the sub-pixels p1, p2 and p3, and thus it is possible to change the white chromaticity coordinates.

Note that, in the structural example of the light shielding members S in the embodiment shown in FIG. 5B, the pairs of light shielding members S are provided in the sub-pixel p2 corresponding to G, and the sub-pixel p3 corresponding to B of the three sub-pixels p1, p2 and p3, respectively. However, in the case where either the liquid crystal alignment controlling factors or the spacers are provided in all the sub-pixels p1, p2 and p3, respectively, a structure may also be adopted such that the light shielding members S are provided in all the sub-pixels p1, p2 and p3, respectively, so as to correspond to that case, and the outer shapes in planar view of the light shielding members S provided in the sub-pixels p1, p2 and p3 are made to have different sizes, respectively.

In addition, the adjustment for the transmittance by using the light shielding member S depends on an area in planar view of the light shielding member S provided in the sub-pixel. Therefore, when the transmittances of the sub-pixels p1, p2 and p3 are adjusted, in addition to making the sizes of the pairs of light shielding members S different from each other in the manner as described above, the adjustment for the transmittances of the sub-pixels may be carried out depending on the numbers of light shielding members provided even when the light shielding members S having the same size are used.

In the liquid crystal display device 1 of the embodiment, a light shielding film provided so as to correspond to either the liquid crystal alignment controlling factor or the spacer provided as the light shielding member S in the sub-pixel is used as the member as well for adjustment for the transmittance of the sub-pixel. As a result, the outer shape in planar view of the light shielding member S is larger than that of either the liquid crystal alignment controlling factor or the spacer. In addition, the light shielding member S is similar in outer shape in planar view to either the liquid crystal alignment controlling factor or the spacer. By adopting such a similar figure, it is possible to sufficiently yield the effect of suppressing the influence of the light leakage due to the presence of either the liquid crystal alignment controlling factor or the spacer. Also, it is possible to exactly carry out the adjustment for the desired transmittance.

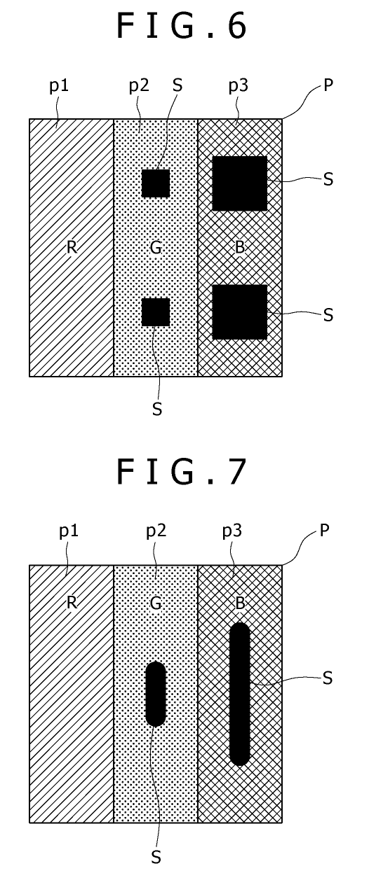

FIGS. 6 and 7 are respectively diagrams explaining other structural examples of light shielding members having other shapes. The structural example of FIG. 6 shows the case where the light shielding member S has a rectangular shape, and the structural example of FIG. 7 shows the case where the light shielding member S has an oval shape. As shown in FIGS. 6 and 7, in addition to the case where the outer shape in planar view of the light shielding member S is the circular shape as shown in FIG. 5, the various shapes can be adopted so as to correspond to the outer shapes in planar view of either the liquid crystal alignment controlling factors or the spacers. It is noted that the light shielding member S may not be necessarily, perfectly similar in outer shape in planar view to either the liquid crystal alignment controlling factor or the spacer as long as the outer shape in planar view of the light shielding member S contains therein that of either the liquid crystal alignment controlling factor or the spacer.

### Example

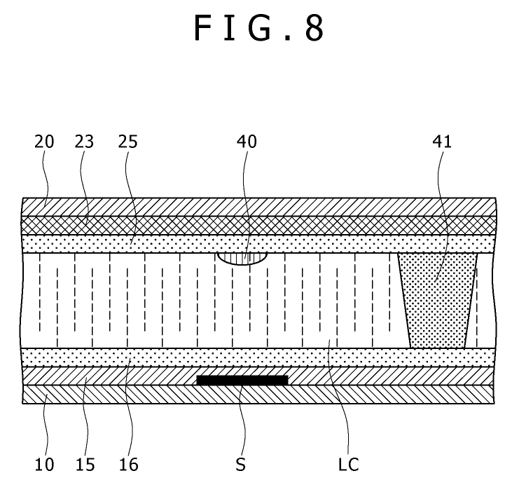

FIG. 8 is a schematic cross sectional view explaining a structure of a sub-pixel of an example. That is, FIG. 8 shows a structure of one sub-pixel of the liquid crystal display device 1 of the embodiment. The liquid crystal LC having a Vertical Alignment (VA) mode is applied to the liquid crystal display device 1 of the embodiment, and a structure in which a protrusion is formed on the counter substrate 20 side with a positive resist is adopted for the alignment control in a liquid crystal alignment controlling factor 40.

In the liquid crystal display device 1, a spacer 41 is disposed between the drive substrate 10 and the counter substrate 20. Thus, a predetermined distance is set between the drive substrate 10 and the counter substrate 20 by the spacer 41. The liquid crystal LC is injected into the space defined between the drive substrate 10 and the counter substrate 20 between which the predetermined distance is set. After completion of the injection of the liquid crystal LC, the inlet 30a (refer to FIG. 1) provided between the drive substrate 10 and the counter substrate 20 is sealed with the sealant 32.

In the liquid crystal display device 1, the liquid crystal alignment controlling factor 40 is provided on the color filter 23 side on the counter substrate 20. In addition, in order to prevent the light leakage caused by the turbulence of the liquid crystal alignment in the liquid crystal alignment controlling factor 40 and the circumference thereof, the light shielding member S, for example, made from a molybdenum (Mo) pattern is provided on the drive substrate 10 side.

The liquid crystal alignment controlling factor 40 has a diameter of about 12 μm, whereas the light shielding member S made from the molybdenum pattern has a diameter of about 16 μm. The reason for this is because the size of the light shielding pattern is decided based on an estimation of a shift length in the phase of sticking the drive substrate 10 and the counter substrate 20 to each other in addition to an area of the light leakage from the circumference of the liquid crystal alignment controlling factor 40.

The light shielding member S can be made in the same process as that for the elements such as the transistor formed on the drive substrate 10 because it is provided on the drive substrate 10 side. As a result, the light shielding member S can be made with a very high precision.

In addition, the light shielding member S is disposed in an independent position within the display area (the area in which the pixel electrode is formed) in the sub-pixel. The independent position stated here means an isolated position which is continuous to none of the scanning lines and the signal lines. As a result, it is possible to carry out the design of the light shielding member S (the adjustment for the transmittance) without exerting an influence on the designs of the scanning lines and the signal lines.

Here, TABLE 1 shows the results of simulating a movement amount of white chromaticity coordinates while the size of the molybdenum (Mo) pattern used as the light shielding member S is changed.

TABLE 1

| | | | | movement | | | |
|---|---|---|---|---|---|---|---|
| | ratio among | | | amount of | | | |
| | aperture ratios | | | coordinates | | transmittance | |
| | R | G | B | u′ | v′ | ratio | CR ratio |
| ref | 1 | 1 | 1 | 0 | 0 | 1 | 1.00 |
| 1 | 1.04 | 1 | 0.934 | 0.003 | 0.005 | 1.00 | 0.98 |
| 2 | 1.04 | 0.987 | 0.934 | 0.003 | 0.004 | 0.99 | 0.97 |
| 3 | 1.04 | 1 | 0.9 | 0.003 | 0.007 | 1 | 0.98 |
| 4 | 1.04 | 0.964 | 1 | 0.003 | −0.001 | 0.99 | 1.04 |
| 5 | 0.9 | 1 | 1 | −0.005 | −0.002 | 0.98 | 1.10 |
| 6 | 1 | 0.9 | 1 | 0.004 | 0.006 | 0.94 | 1.01 |
| 7 | 1 | 1 | 0.9 | 0.001 | 0.007 | 0.99 | 1.00 |

TABLE 1 shows the results of simulating an amount of white chromaticity coordinates (u′, v′), a transmittance ratio and a contrast ratio (CR ratio) with a different aperture ratios under the conditions 1 to 7 by using the same ratio among the aperture ratios of corresponding sub-pixels of the sub-pixels corresponding to R, G and B, respectively, as a reference (ref). The condition 1 was selected as a combination, with which reduction of the contrast can be decreased without reducing the transmittance, of the combinations of the movement amount of white chromaticity coordinates, and the size of the light shielding members from the conditions 1 to 7 shown in TABLE 1. Under the condition 1, actually, the liquid crystal display device was manufactured. With regard to the actual characteristics of the liquid crystal display device thus manufactured, the movement amount of white chromaticity coordinates, and the transmittance were each as expected, and the radiation in contrast was about 2%.

Each of the contrast and the contribution of the contrast is proportional to the luminance of the single color, and in this liquid crystal display device, R:G:B=3:7:1 is obtained as the ratio of the luminance. Therefore, the light shielding area of the sub-pixel corresponding to Blue (B), having the less deterioration of the transmittance is increased, and the high transmittance of the sub-pixel, corresponding to Red (R), having the relatively less deterioration of the contrast is obtained, which results in that the reduction in contrast can be held to a minimum while the transmittance is ensured.

### Another Example

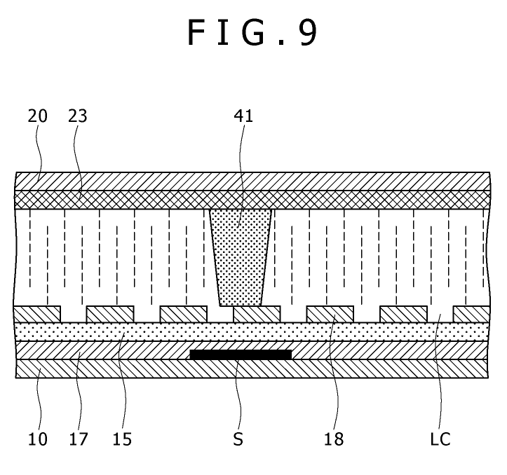

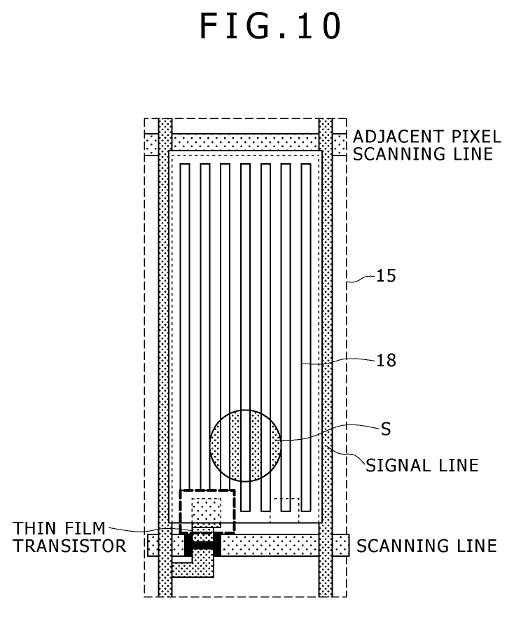

FIG. 9 is a schematic cross sectional view explaining a structure of a sub-pixel of another example, and FIG. 10 is a schematic top plan view explaining the structure of the sub-pixel of the another example.

The liquid crystal LC having a Fringe Field Switching (FFS) mode is applied to the another example of the embodiment. Thus, the common electrode 17 is formed on the drive substrate 10 side, and the pixel electrodes 18 are formed on the drive substrate 10 side through an insulating film 15. In addition, the color filter 23 is formed on the counter substrate 20 side. Also, the spacer 41 composed of a photo spacer (PS) is disposed on the counter substrate 20 side for the purpose of holding the distance between the drive substrate 10 and the counter substrate 20. The light shielding member S formed from the molybdenum (Mo) pattern is disposed on the drive substrate 10 side.

In the liquid crystal display device 1, a predetermined distance is set between the drive substrate 10 and the counter substrate 20 by disposing the spacer 41 between the drive substrate 10 and the counter substrate 20. The liquid crystal is injected into the space defined between the drive substrate 10 and the counter substrate 20 through the inlet 30a (refer to FIG. 1) provided between the drive substrate 10 and the counter substrate 20. After completion of the injection of the liquid crystal, the inlet 30a (refer to FIG. 1) provided between the drive substrate 10 and the counter substrate 20 is sealed with the sealant 32.

In the liquid crystal display device 1, the light shielding member S is formed in the position facing the spacer 41 on the drive substrate 10 side for the purpose of light-shielding the light leakage from the circumference of the spacer 41 composed of the PS formed so as to have an arbitrary color on the color filter 23 on the counter substrate 20.

The light shielding member S can be made in the same process as that for the elements such as the transistor formed on the drive substrate 10 because it is provide on the drive substrate 10 side. As a result, the light shielding member S can be made with a very high precision.

In addition, as shown in FIG. 10, the light shielding member S is disposed in an independent position within the display area (the area in which the pixel electrode is formed) in the sub-pixel. The independent position stated here means an isolated position which is continuous to none of the scanning lines and the signal lines. As a result, it is possible to carry out the design of the light shielding member S (the adjustment for the transmittance) without exerting an influence on the designs of the scanning lines and the signal lines.

The spacer 41 has a diameter of about 11 μm, whereas the light shielding member S formed from the molybdenum (Mo) pattern has a diameter of about 24 μm. The white chromaticity coordinates change as shown in TABLE 2 due to the colors to which the pixels each having the light shielding member S disposed therein correspond. TABLE 2 shows changes (Δx and Δy in the x-y color space) of the white chromaticity coordinates when the spacer 41 and the light shielding member S are disposed in each of the sub-pixels corresponding to R, G and B, respectively.

TABLE 2

| | Δx | Δy |
|---|---|---|
| Red | −0.005 | 0.000 |
| column | | |
| Green | −0.001 | −0.008 |
| column | | |
| Blue | 0.006 | 0.008 |
| column | | |

In another example, the spacer 41 and the light shielding member S were disposed in the sub-pixel corresponding to Red (R) in consideration of a direction along which the white chromaticity coordinates are desired to be moved. In addition, the spacer 41 and the light shielding member S may be provided in each of two or more sub-pixels of every three sub-pixels corresponding to R, G and B, respectively, as may be necessary.

### Still Another Example

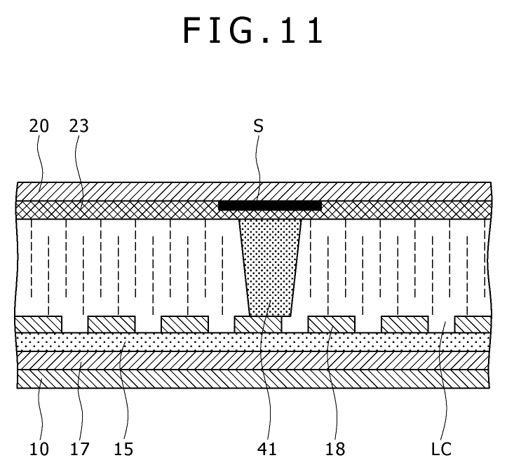

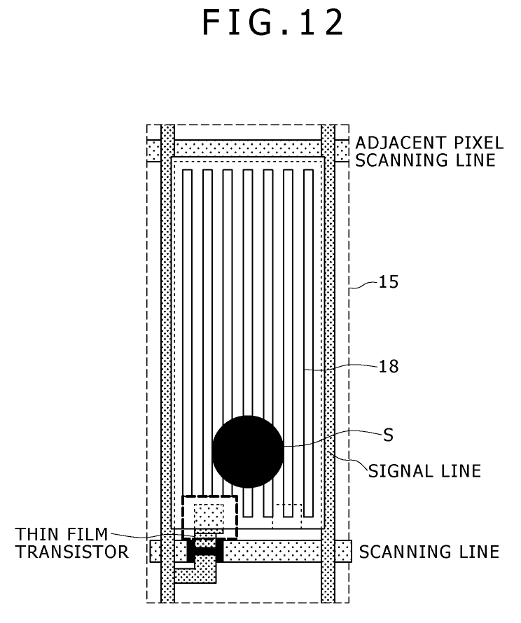

It is noted that Black (BLK) of the color filter may be used as the light shielding member S formed so as to correspond to the spacer 41. In this case, the same effects as those of the above can be obtained. FIG. 11 is a schematic cross sectional view showing a structure of a sub-pixel of still another example in which a color filter is provided with a light shielding member. FIG. 12 is a schematic top plan view showing the structure of the sub-pixel of the still another example in which the color filter is provided with the light shielding member.

In the liquid crystal display device 1, the basic structure that the common electrode 17, the insulating film 15 and the pixel electrodes 18 are formed on the drive substrate 10 side, the color filter 23 is formed on the counter substrate 20 side, and the spacer 41 is provided between the drive substrate 10 and the counter substrate 20 is the same as that in another example. However, the still another example is different from another example in that a pattern of black provided in the color filter 23 on the counter substrate 20 is used as the light shielding member S formed so as to correspond to the spacer 41. The Black pattern may be made of any one of a chromium oxide or a pigment dispersed resist which is normally used in the color filter.

As shown in FIG. 12, the light shielding member S is disposed in an independent position within the display area in the sub-pixel (the formation area of the pixel electrode). As a result, the design of the light shielding member S (the adjustment for the transmittance) can be carried out without exerting an influence on the designs of the scanning lines and the signal lines. In addition, the light shielding member S is larger in outer shape in planar view than the spacer 41. Thus, the light shielding member S is similar in outer shape in planar view to the spacer 41.

### Yet Another Example

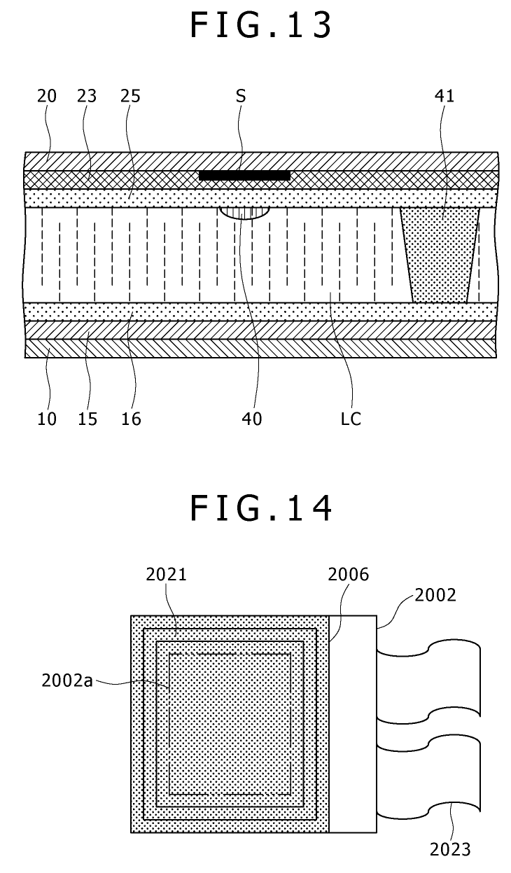

The structure in which the Black pattern of the color filter 23 on the counter substrate 20 is used as the light shielding member S can be applied even to the structure in which the liquid crystal alignment controlling factor 40 shown in FIG. 13 is provided (yet another example). That is to say, in the structure in which as shown in FIG. 13, the liquid crystal alignment controlling factor 40 is provided on the color filter 23 side on the counter substrate 20, the light shielding member S of the Black pattern is formed in the color filter 23 corresponding to the position of the liquid crystal alignment controlling factor 40. The black pattern may be made of any one of a chromium oxide or a pigment dispersed resist which is normally used in the color filter.

The light shielding member S is disposed in an independent position within the display area in the sub-pixel (the formation area of the pixel electrode). As a result, the design of the light shielding member S (the adjustment for the transmittance) can be carried out without exerting an influence on the designs of the scanning lines and the signal lines. In addition, the light shielding member S is larger in outer shape in planar view than the liquid crystal alignment controlling factor 40. Thus, the light shielding member S is similar in outer shape in planar view to the liquid crystal alignment controlling factor 40.

### Other Examples

In the structure in which the light shielding member S is provided on the drive substrate 10 side, a metallic film of which a subsidiary capacitor (Cs) is composed is diverted to the light shielding member S, and an area not contributing to the subsidiary capacitor is extended. As a result, it is possible to obtain the same effect as that of the light shielding member S.

In addition, the combination use of the light shielding member S corresponding to the spacer 41 with the member for adjustment for the transmittances of the sub-pixels is especially by no means limited to the liquid crystal having the FFS mode. Thus, the light shielding member S corresponding to the spacer 41 can be applied irrespective of the mode of the liquid crystal as long as the spacer 41 is similarly formed and the light shielding is necessary for the spacer 41. In particular, using the Black pattern of the color filter as the light shielding member S becomes the effective means because it exerts no influence on the design of the pixel portion.

### Effect of the Embodiment

The chromaticity of the color filter can be made to correspond to the white chromaticity coordinates corresponding to the specification of the product without being changed. Therefore, it becomes possible to respond to the desired specification while the reduction in characteristics is suppressed. In addition, since the light shielding section previously disposed is used as the light shielding member S as well, the response thereto becomes possible merely by simply changing the design of the mask for the photolithography process in forming the pattern on the drive substrate 10 or the counter substrate 20. As a result, it is possible to suppress an increase in manufacturing time or the cost-up.

Next, a description will be given with respect to examples of application of the liquid crystal display device according to the embodiment of the present invention.

### Electronic Apparatuses

The liquid crystal display device of the embodiment includes flat type module shaped one as shown in FIG. 14. For example, a display module is obtained as follows. That is to say, a pixel array portion 2002a is provided in which pixels each composed of a liquid crystal element, a thin film transistor, a thin film capacitor, a light receiving element, and the like are formed in a matrix integrally with one another on an insulating substrate 2002. An adhesive agent 2021 is disposed so as to surround the pixel array portion (pixel matrix portion) 2002a. Also, a counter substrate 2006 made of a glass or the like is stuck to the insulating substrate 2002, thereby obtaining the display module. The transparent counter substrate 2006 may be provided with a color filter, a protective film, a light shielding film, and the like as may be necessary. The display module may be provided with a flexible printed circuit board (FPC) 2023 as a connector through which a signal or the like is inputted/outputted to/from the pixel array portion 2002a from/to the outside.

The liquid crystal display device according to the embodiment of the present invention described above can be applied to liquid crystal display devices, of electronic apparatuses in all the fields, in each of which a video signal inputted to the electronic apparatus, or a video signal generated in the electronic apparatus is displayed in the form of an image or a video image. These electronic apparatuses are typified by various electronic apparatuses, shown in FIG. 15 to FIGS. 19A to 19G, such as a digital camera, a notebook-size personal computer, mobile terminal equipment such as a mobile phone, and a video camera. Hereinafter, examples of electronic apparatuses to each of which the liquid crystal display device according to the embodiment of the present invention is applied will be described.

FIG. 15 is a perspective view showing a television set, as an example of application, to which the embodiment of the present invention is applied. The television set according to the example of application includes an image display screen portion 101 composed of a front panel 102, a filter glass 103, and the like. Also, the television set is manufactured by using the liquid crystal display device according to the embodiment of the present invention as the image display screen portion 101.

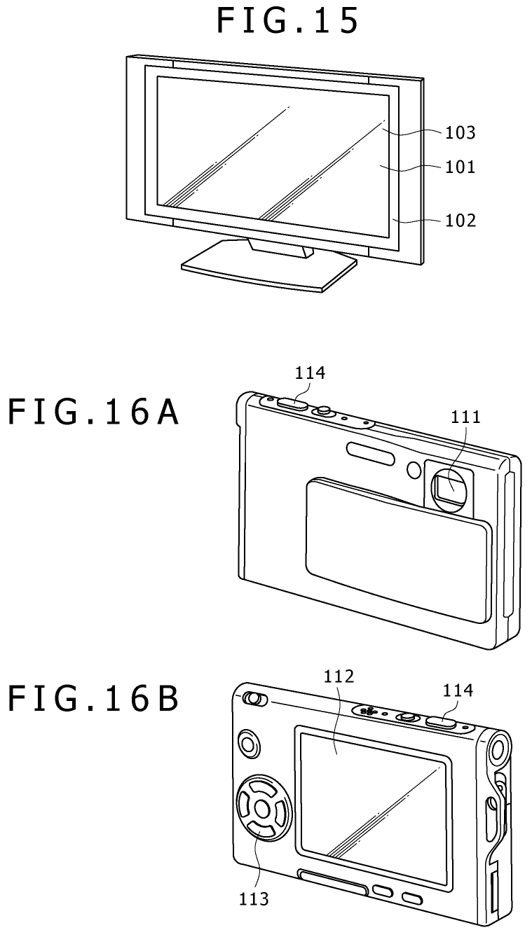

FIGS. 16A and 16B are respectively perspective views each showing a digital camera, as another example of application, to which the embodiment of the present invention is applied. FIG. 16A is a perspective view when the digital camera is viewed from a front side, and FIG. 16B is a perspective view when the digital camera is viewed from a back side. The digital camera according to another example of application includes a light emitting portion 111 for flash, a display portion 112, a menu switch 113, a shutter button 114, and the like. The digital camera is manufactured by using the liquid crystal display device according to the embodiment of the present invention as the display portion 112.

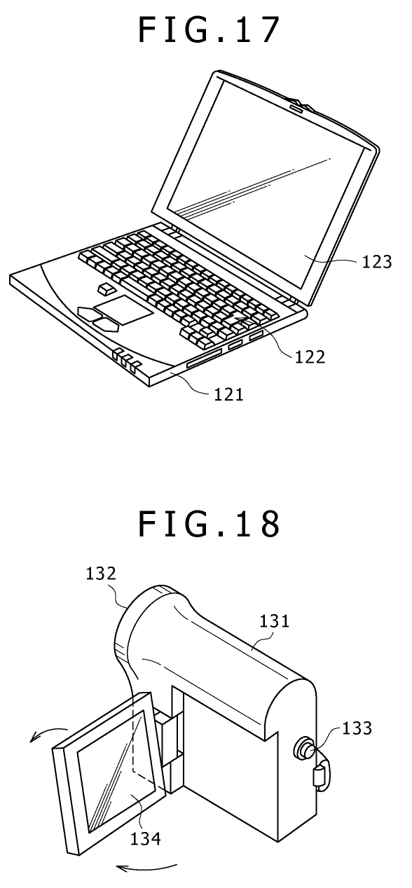

FIG. 17 is a perspective view showing a notebook-size personal computer, as still another example of application, to which the embodiment of the present invention is applied. The notebook-size personal computer according to the still another example of application includes a main body 121, a keyboard 122 which is manipulated when characters or the like are inputted, a display portion 123 for displaying thereon an image, and the like. The notebook-size personal computer is manufactured by using the liquid crystal display device according to the embodiment of the present invention as the display portion 123.

FIG. 18 is a perspective view showing a video camera, as yet another example of application, to which the embodiment of the present invention is applied. The video camera according to the yet another example of application includes a main body portion 131, a lens 132 which captures an image of a subject and which is provided on a side surface directed forward, a start/stop switch 133 which is manipulated when an image of a subject is captured, a display portion 134, and the like. The video camera is manufactured by using the liquid crystal display device according to the embodiment of the present invention as the display portion 134.

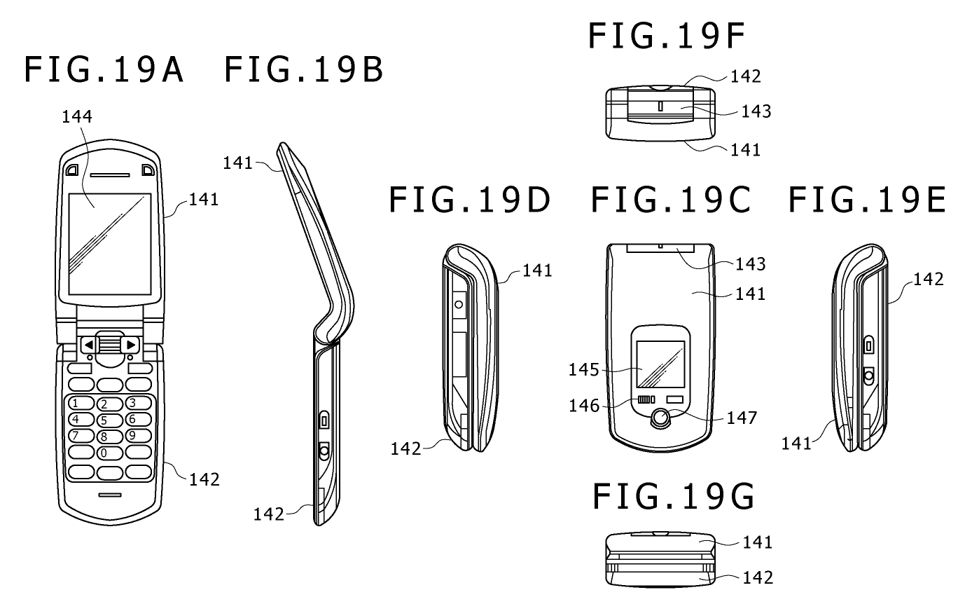

FIGS. 19A to 19G are respectively views showing mobile terminal equipment, for example, mobile phone, as a further example of application, to which the embodiment of the present invention is applied. FIG. 19A is a front view in an open state of the mobile phone, FIG. 19B is a side elevational view in the open state of the mobile phone, FIG. 19C is a front view in a close state of the mobile phone, FIG. 19D is a left side elevational view of the mobile phone, FIG. 19E is a right side elevational view of the mobile phone, and FIG. 19G is a bottom view of the mobile phone. The mobile phone according to the further example of application includes an upper chassis 141, a lower chassis 142, a connection portion (a hinge portion in this case) 143, a display portion 144, a sub-display portion 145, a picture light 146, a camera 147, and the like. The mobile phone is manufactured by using the liquid crystal display device according to the embodiment of the present invention as the display portion 144 or the sub-display portion 145.

### Display Image Pickup Device

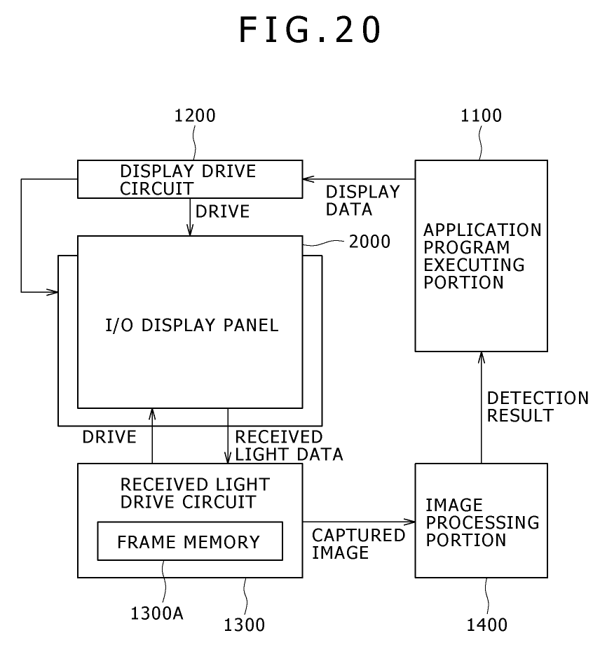

The liquid crystal display device according to the embodiment of the present invention can be applied to a display image pickup device which will be described below. In addition, the display image pickup device can be applied to electronic apparatuses described above. FIG. 20 shows an entire configuration of the display image pickup device. The display image pickup device includes an I/O display panel 2000, a backlight 1500, a display device circuit 1200, a received light drive circuit 1300, an image processing portion 1400, and an application program executing portion 1100.

The I/O display panel 2000 is composed of a Liquid Crystal Display (LCD) panel in which a plurality of pixels are disposed in a matrix over an entire surface. The I/O display panel 2000 has a display function and an image pickup function. With the display function, an image such as a predetermined figure or characters based on display data is displayed while a line-sequential operation is carried out. Also, with the image pickup function, an image of an object which contacts or approaches the I/O display panel 2000 as will be described later is captured. In addition, the backlight 1500 is a light source for the I/O display panel 2000 in which, for example, a plurality of light emitting diodes are disposed. The backlight 1500 carries out an ON/OFF operation at a high speed at a predetermined timing synchronous with an operation of the I/O display panel 2000.

The display drive circuit 1200 is a circuit for driving the I/O display panel 2000 (for driving the line-sequential operation) so that an image based on the display data is displayed on the I/O display panel 2000 (so that the display operation is carried out).

The light receiving circuit 1300 is a circuit for driving the I/O display panel 2000 (for driving the line-sequential operation) so that data on the received lights is obtained in the I/O display panel 2000 (so that an image of an object is captured). It is noted that the data on the received lights in the respective pixels, for example, is accumulated in frames in a frame memory 1300A, and is then outputted to the image processing portion 1400 as the captured image.

The image processing portion 1400 executes predetermined image processing (arithmetic operating processing) based on the captured image which is outputted from the received light drive circuit 1300, thereby detecting and acquiring information on the object (such as position coordinate data, and data on a shape and a size of the object) which contacts or approaches the I/O display panel 2000.

The application program executing portion 1100 executes processing corresponding to predetermined application software based on the detection results obtained from the image processing portion 1400. For example, processing for containing the position coordinates of the detected object in the display data, and displaying the display data on the I/O display panel 2000, and the like are given as the processing described above. It is noted that the display data generated from the application program executing portion 1100 is supplied to the display drive circuit 1200.

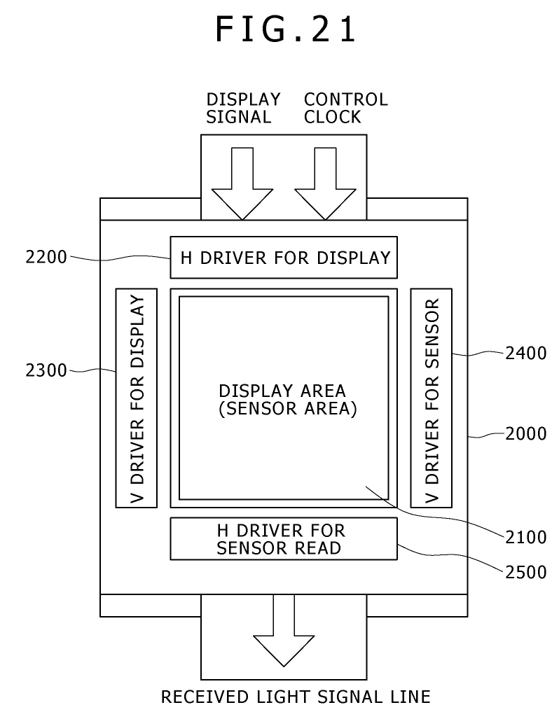

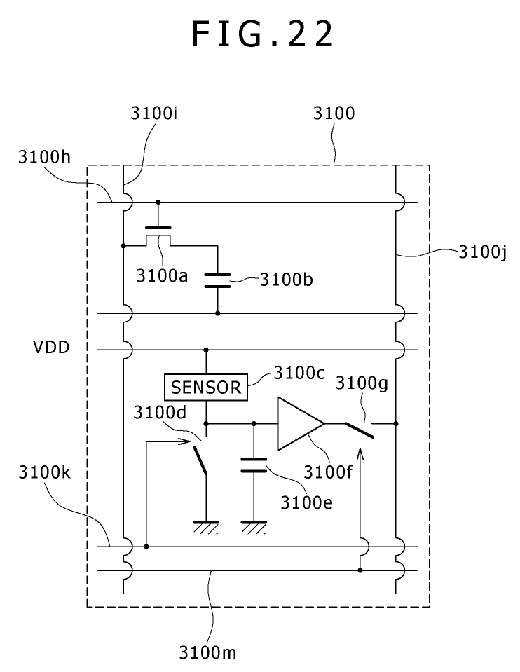

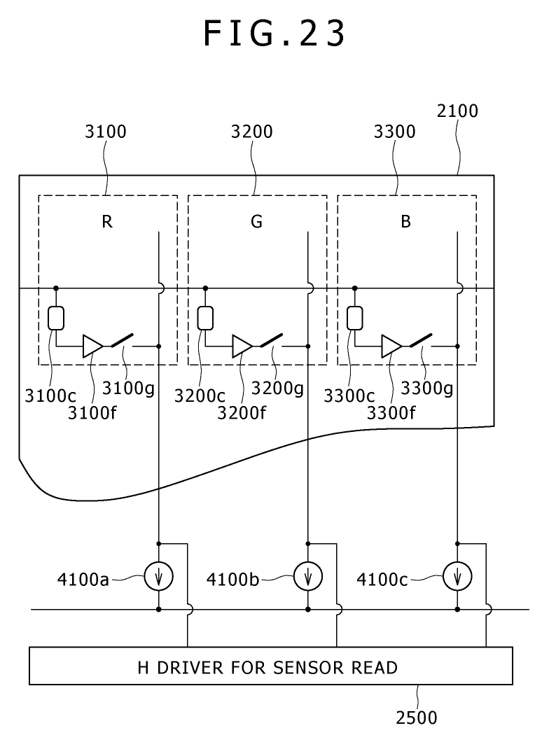

Next, a detailed configuration of the I/O display panel 2000 will be described with reference to FIG. 21. The I/O display panel 2000 includes a display area (sensor area) 2100, an H driver 2200 for display, a V driver 2300 for display, an H driver 2500 for sensor read, and a driver 2400 for a sensor.

The display area (sensor area) 2100 is an area through which a light from the backlight 1500 is modulated to radiate a display light, and an image of an object contacting or approaching this area is captured. Also, the liquid crystal elements as emission elements (display elements), and light receiving elements (image pickup elements) which will be described later are each disposed in a matrix, respectively.

The H driver 2200 for display drives the liquid crystal elements of the pixels within the display area 2100 in the line-sequential manner together with the V driver 2300 for display in accordance with a display signal for display drive, and a control clock which are supplied from the display drive circuit 1200.

The H driver 2500 for sensor read drives the light receiving elements of the pixels within the sensor area 2100 in the line-sequential manner together with the V driver 2400 for a sensor, thereby acquiring a light reception signal.

Next, a detailed configuration of each of pixels in the display area 2100 will be described with reference to FIG. 22. A pixel 3100 shown in FIG. 22 is composed of a liquid crystal element as a display element, and a light receiving element.

Specifically, a switching element 3100a composed of a thin film transistor or the like is disposed in an intersection between a horizontally extending gate electrode 3100h, and a vertically extending drain electrode 3100i on the display element side. A pixel electrode 3100b including the liquid crystal is disposed between the switching element 3100a and the counter electrode. Also, the switching element 3100a is turned ON or OFF in accordance with a drive signal supplied thereto through the gate electrode 3100h. When the switching element 3100a is held in an ON state, a pixel voltage is applied to the pixel electrode 3100b in accordance with a display signal supplied to the switching element 3100a through the drain electrode 3100i, thereby setting a display state.

On the other hand, a light receiving sensor 3100c, for example, composed of a photodiode or the like is disposed on the side of the light receiving element adjacent to the display element, and thus a power source voltage VDD is adopted to be supplied to the light receiving sensor 3100c. A reset switch 3100d and a capacitor 3100e are each connected to the light receiving sensor 3100c. Thus, the electric charges corresponding to a quantity of received lights are accumulated in the capacitor 3100e while the light receiving sensor 3100c is reset by the reset switch 3100d. Also, the electric charges thus accumulated are supplied to an electrode 3100j for signal output through a buffer amplifier 3100f at a timing at which the read switch 3100g is turned ON, and are then outputted to the outside. In addition, an ON/OFF operation of the reset switch 3100d is controlled in accordance with a signal supplied from a reset electrode 3100k, and an ON/OFF operation of the read switch 3100g is controlled in accordance with a signal supplied from a read control electrode 3100k.

Next, a connection relationship between each of the pixels within the display area 2100, and the H driver 2500 for sensor read will be described with reference to FIG. 23. In the display area 2100, a sub-pixel 3100 for Red (R), a sub-pixel 3200 for Green (G), and a sub-pixel 3300 for Blue (B) are displayed side by side.

The electric charges accumulated in capacitors connected to light receiving sensors 3100c, 3200c and 3300c of the sub-pixels 3100, 3200 and 3300, respectively, are amplified by buffers 3100f, 3200f and 3300f, respectively, and are supplied to the H driver 2500 for sensor read through the electrodes for signal output at a timing at which each of the read switches 3100g, 3200g and 3300g is turned ON. It is noted that constant current sources 4100a, 4100b and 4100c are connected to the electrodes for signal output, respectively, which results in that the H driver 2500 for sensor read detects signals corresponding to quantities of received lights, respectively, at a high sensitivity.

Next, an operation of the display image pickup device to which the liquid crystal display device 1 of the embodiment is applied will be described in detail.

Firstly, a description will be given with respect to a basic operation of the display image pickup device, that is, an operation for displaying an image, and an operation for capturing an image of an object.

In the display image pickup device, a drive signal for display is generated in the drive circuit 1200 for display based on the display data supplied from the application program executing portion 1100. Also, the line-sequential display drive is carried out for the I/O display panel 2000 in accordance with the drive signal, thereby displaying an image on the I/O display panel 2000. At this time, the backlight 1500 is also driven by the display drive circuit 1200, and thus a radiation/non-radiation operation is carried out synchronously with the operation of the I/O display panel 2000.

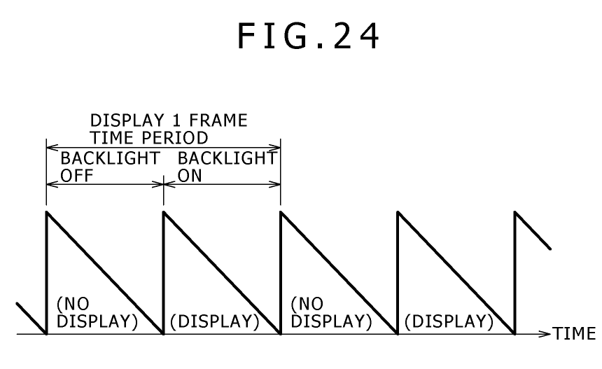

Here, a relationship between an ON/OFF state of the backlight 1500, and the display state of the I/O display panel 2000 will be described with reference to FIG. 24. In FIG. 24, an axis of abscissa represents time, and an axis of ordinate represents a position of a row in a vertical direction along which the light receiving elements of the pixels are successively scanned for image capturing.

Firstly, when, for example, the image display is made with a frame period of ( 1/60) seconds, the backlight 1500 is put OFF (turned OFF) for a time period of the first half (for ( 1/120) seconds) of each of the frame time periods, and thus no display is made. On the other hand, for a time period of the second half of each of the frame time periods, the backlight 1500 is put ON (turned ON). As a result, the display signal is supplied to the pixels, and an image corresponding to the frame time period concerned is displayed.

As has been described, the time period of the first half of each of the frame time periods is a non-radiation time period for which no display light is radiated from the I/O display panel 2000. On the other hand, the time period of the second half of each of the frame time periods is a radiation time period for which the display light is radiated from the I/O display panel 2000.

Here, when there is an object (for example, a fingertip or the like) contacting or approaching the I/O display panel 2000, an image of the object is captured in the light receiving elements of the pixels in the I/O display panel 2000 by carrying out the received light driving operation in the line-sequential manner by the received light drive circuit 1300. Also, the received light signals are supplied from the light receiving elements to the received light drive circuit 1300. In the received light drive circuit 1300, the received light signals for one frame from the pixels are accumulated, and are then outputted to the image processing portion 1400 as the captured image.

Also, the image processing portion 1400 executes the predetermined image processing (arithmetic operation processing) based on the captured image. As a result, there is detected the information on the object (the position coordinate data, the data on the shape and size of the object, and the like) contacting or approaching the I/O display panel 2000.

As an example, a difference in data between the captured image for an invalid time period, and a captured image for a valid time period, which results in that it is possible to remove the outside light, and thus it is possible to obtain the image information based on the light which is radiated from the backlight 1500 to be reflected by the object contacting or approaching the I/O display panel 2000 for the valid time period. The image processing or the like for extracting the data each equal or larger than a predetermined threshold from the image information, and binarizing the data thus extracted, thereby obtaining the coordinates of the center of gravity. As a result, the information about the object contacting or approaching the I/O display panel 2000 is obtained.

In addition, when the infrared light for detection is radiated together with the visible light from the backlight 1500, the backlight 1500 may be normally turned ON for radiation of the visible light component by carrying out the ON/OFF operation for radiation of the infrared light component.

It should be understood by those skilled in the art that various modifications, combinations, sub-combinations and alterations may occur depending on design requirements and other factor in so far as they are within the scope of the appended claims or the equivalents thereof.

What is claimed is:

1. A liquid crystal display device having a liquid crystal between a drive substrate and a counter substrate, and a plurality of main pixels disposed so as to compose a display area,
wherein either a liquid crystal alignment controlling factor or a spacer for substrate distance setting is provided in each of at least two sub-pixels of a plurality of sub-pixels composing said main pixel; and
light shielding members provided in said at least two sub-pixels so as to correspond to either the liquid crystal alignment controlling factors or the spacers, respectively, are different in area in planar view from each other.

2. The liquid crystal display device according to claim 1, wherein said light shielding member is similar in shape to an outer shape in planer view of either said liquid crystal alignment controlling factor or said spacer.

3. The liquid crystal display device according to claim 1, wherein the light shielding members are disposed within a display area independently of each other.

4. The liquid crystal display device according to claim 1, wherein the light shielding members are provided on a side of said drive substrate.

5. The liquid crystal display device according to claim 1, wherein the light shielding members are provided within a transparent electrode provided on a side of said drive substrate.

6. The liquid crystal display device according to claim 1, wherein the light shielding members are provided on a side of said counter substrate.

7. The liquid crystal display device according to claim 1, wherein the light shielding members are provided within a color filter provided on a side of said counter substrate.

8. An electronic apparatus including a liquid crystal display device provided in a main body chassis,
wherein in said liquid crystal display device, a liquid crystal is sealingly enclosed between a drive substrate and a counter substrate, and a plurality of main pixels are disposed so as to compose a display area;
either a liquid crystal alignment controlling factor or a spacer for substrate distance setting is provided in each of at least two sub-pixels of a plurality of sub-pixels composing the main pixel; and
light shielding members provided in said at least two sub-pixels so as to correspond to either the liquid crystal alignment controlling factors or the spacers, respectively, are different in area in planar view from each other.
